(19) United States
(12) Patent Application Publication
(10) Pub. No.: US 2019/0366862 A1
(43) Pub. Date: Dec. 5, 2019

(54) CHARGING STATIONS FOR BIKES AND E-SCOOTERS

(71) Applicant: Mark A. Anton, Newport Beach, CA (US)

(72) Inventor: Mark A. Anton, Newport Beach, CA (US)

(21) Appl. No.: 16/430,297

(22) Filed: Jun. 3, 2019

Related U.S. Application Data
(60) Provisional application No. 62/681,034, filed on Jun. 5, 2018.
(60) Provisional application No. 62/732,520, filed on Sep. 17, 2018.

(51) Int. Cl. B60L 53/30; H02J 7/00; H02J 7/35; B60L 53/51; B60L 53/66; B62H 3/12

(52) U.S. Cl. CPC B60L 53/30; H02J 7/0027; H02J 7/355; B60L 53/51; B60L 53/66; B62K 11/00; H02J 2007/0098; B60L 2200/12; B60Y 2200/91; B60Y 2300/91; B62K 2202/00; B62H 3/12

(57) ABSTRACT

A parking and charging station for electric vehicles, the parking and charging station has a small footprint and data transfer capability. The electric vehicles may include e-bikes and e-scooters, but other similar vehicles may also be supported. The parking and charging station may include a vertical automatic and motorized conveyor. The parking and charging station may include a standalone vertical post with one or more bars attached horizontally.

### CROSS REFERENCE TO RELATED APPLICATIONS

The present application claims priority pursuant to U.S.C. § 119(e) to U.S. Provisional Patent Application No. 62/681,034 filed Jun. 5, 2018, and to U.S. Provisional Patent Application No. 62/732,520 filed Sep. 17, 2018, the entire contents and disclosures of each of which are hereby incorporated by reference in their entireties.

The present application is related to U.S. Non-Provisional application Ser. No. 15/054,001 filed Feb. 25, 2016 now U.S. Pat. No. 10,077,005, U.S. Provisional Application No. 62/276,144 filed Jan. 7, 2016, U.S. Provisional Application No. 62/163,638 filed May 19, 2015, and U.S. Provisional Application No. 62/120,825 filed Feb. 25, 2015, the entire contents and disclosures of which are hereby incorporated by reference in their entireties. The present application is also related to U.S. Non-Provisional application Ser. No. 14/214,407 filed Mar. 14, 2014 now U.S. Pat. No. 9,290,132, U.S. Provisional Application No. 61/803,101 filed Mar. 18, 2013 and U.S. Provisional Application No. 61/801,951 filed Mar. 15, 2013, the entire contents and disclosures of all of which are hereby incorporated by reference in their entireties. The present application is also related to U.S. Pat. No. 6,752,302 by Anton, patented Jun. 22, 2004, the entire contents and disclosures of which are hereby incorporated by reference in its entirety. The present application is also related to U.S. Non-Provisional application Ser. No. 15/711,720, filed Sep. 21, 2017, U.S. Provisional Application No. 62/554,767 filed Sep. 6, 2017, U.S. Provisional Application No. 62/545,409 filed Aug. 14, 2017, U.S. Provisional Application No. 62/462,285 filed Feb. 22, 2017, U.S. Provisional Application No. 62/431,792 filed Dec. 8, 2016, U.S. Provisional Application No. 62/397,896 filed Sep. 21, 2016, the entire contents and disclosures of which are hereby incorporated by reference in their entireties.

### FIELD

The subject matter described herein relates generally to parking station, in particular, to an automatic vehicle conveyor hub for parking and charging vehicles, including bikes, electric bikes (e-bikes), scooters, electric scooters (e-scooters), and the like.

### BACKGROUND

The electric vehicle markets, including electric bike market, have grown steadily in the last few years. The global market for electric bicycles alone is about 16 billion US dollars in 2016 and can grow to about 25 billion US dollars in 2025. Currently, although there are some public parking and charging spaces/stations for electric cars, none currently exist for electric bikes, electric scooters (which may be referred to as e-bikes and e-scooters), and the like. There are some fleet e-bike companies that pay users to pick up their bikes around town, take them home and charge them. The electric bike market is poised to explode by more than 2000% in the next 10 years and as such, public charging stations for e-bikes will be in great demand in the near future, for private and fleet owned e-bikes. E-bikes and e-scooters will become an integral part of smart mobility which involves a future paradigm shift in multi-modal transportation (e.g., for e-bikes, e-scooters, e-cars, e-buses and other public vehicles). Companies will need to communicate with and transfer data to/from the parking stations for inventory and control.

Thus, needs exist for systems and methods for public parking and charging stations for electric vehicles, including for e-bikes, e-scooters and the like, with universal charging and locking mechanisms. The stations provide among other benefits, space saving footprint and data transfer ability, without the above mentioned and other disadvantages.

### SUMMARY

Provided herein are example embodiments of systems, devices and methods for providing a parking and charging station for electric vehicles, the parking and charging station has a small footprint and data transfer capability. The electric vehicles may include e-bikes and e-scooters, but other similar vehicles may also be supported. For simplicity, the disclosure may refer to bike, e-bike, scooter, e-scooter and the likes as just bike or e-bike.

Generally, the parking and charging station of the present disclosure, in the form of a hard-wired or solar powered station (or hub) may allow e-bikes, e-scooters and the like be locked, charged. The parking and charging station may have data transfer and communication capabilities. In some embodiments, the data transfer capabilities may include, for example, the ability to pay for parking via a software application (or “app”) on a smart device, e.g., smart phone, tablet, smart watch, etc. The locking mechanism on the parking and charging station (or hub) may include magnetic locking and unlocking, which, in some embodiments, may be controlled by a remote server, or the app on a person's smart device.

In some embodiments, the parking and charging station of the present disclosure may include a vertical automatic and motorized conveyor. The vertical automatic conveyor may be built as stand-alone structure, or integrated into a vertical structure, e.g., a wall.

In some embodiments, the parking and charging station of the present disclosure may include a vertical post which may include one or more bars attached horizontally to the post. The bar may include a plurality of mounts providing dual functions of charging and locking of the bike(s) docked to the bar.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated in and constitute a part of the specification, are for illustrative purposes only of selected embodiments, serve to explain the principles of the invention. These drawings do not describe all possible implementations and are not intended to limit the scope of the present disclosure.

FIG. 1 shows an exemplary view of a parking and charging station, according to various embodiments.

FIG. 2 shows an exemplary partial side (profile) view of a parking and charging station, according to various embodiments.

FIG. 3 shows an exemplary sectional side view of a rotating connecting mechanism, according to various embodiments

FIG. 4 shows an exemplary top or aerial view of a parking and charging station system, according to various embodiments.

FIG. 5 shows an exemplary front view of one conveyor of the parking and charging station system of FIG. 4, according to various embodiments.

FIG. 6 shows an exemplary public charging station, according to various embodiments.

### DETAILED DESCRIPTION

The present disclosure relates to systems, devices and methods for a public parking and charging station for electric vehicles, the parking and charging station has a small footprint and data transfer capability.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

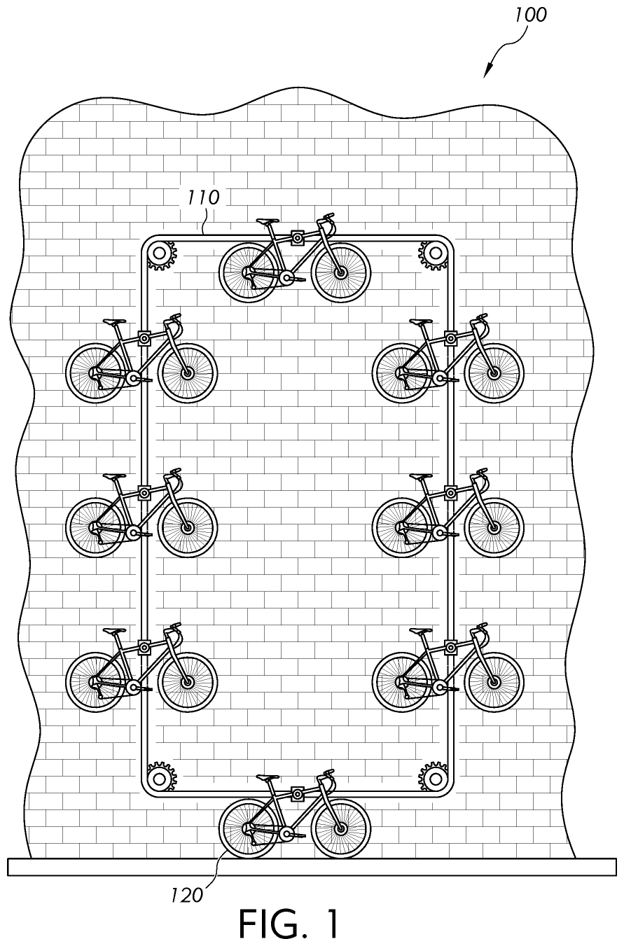

Referring to the figures, FIG. 1 illustrates an exemplary view of a parking and charging station 100 for all types of electric and non-electric bikes (including scooters), according to some embodiments of the present disclosure. The bikes can be attached via universal link and carrier bar similar to those described in U.S. patent application Ser. No. 15/711,720, or to the support bar or carrier bar described in U.S. patent application Ser. No. 15/054,001, and its multiple variations that have been previously described for motor vehicles and buildings (homes, apartments, businesses, etc.) can also be applied to the present disclosure. Each carrier bar may include single or multiple mounting connectors (or universal links or mounts) for mounting a single bike or multiple bikes. The mount may include locking mechanism which, in some embodiments, may be controlled by a remote server, or an app on a person's smart device. In some embodiments, the locking mechanism may be magnetic.

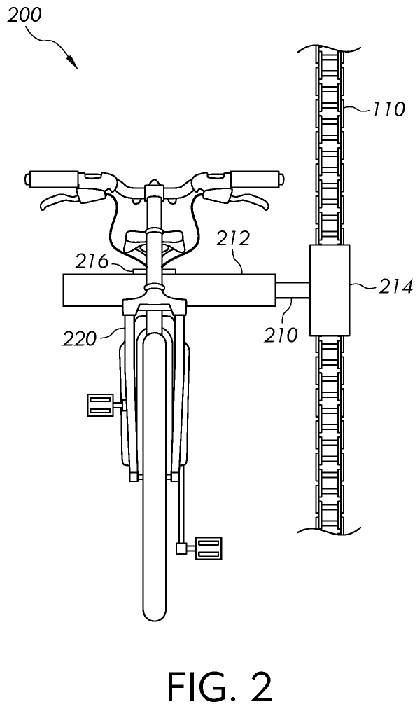

In some embodiments, the parking and charging station 100 may include a vertical conveyor 110 that rotates around until space 120 for parking a bike comes around. The conveyor 110 may rotate on connecting chain, wire, band, or suitable mechanism. The mounted bike stays level as the conveyor 110 rotates. This setup has a relatively small footprint (for example, about 2 feet wide (deep) by 14 feet long (wide)) to carry multiple bikes or scooters that can be secured to a carrier bar (see FIG. 2), one or more at a time, depending on the conveyor's capabilities. It should be noted that the measurements are flexible to accommodate the sizes of bikes and scooters, and sizes of the parking area. In the above example, a bike is generally 2 feet wide and 6 feet long, as such the footprint of about 2 feet wide (deep) by 14 feet long can allow the space for the two bikes shown side by side with some space in between them.

It should also be noted that although FIG. 1 illustrates a system of two-story high, the system of the present disclosure can be one-story high, two-story high, three-story high, and so on. For example, a one-story system may accommodate up to 4 bikes in single mount, or up to 8 bikes if double mount (which will be described further below), a two-story system may accommodate up to 8 bikes in single mount, or up to 16 bikes if double mount, a three-story system may accommodate up to 14 bikes in single mount, or up to 28 bikes if double mount, and so on. Also, although FIG. 1 shows one bike at the top and one bike at the bottom, if a parking area is longer (wider), the conveyor 110 may be longer, and it may support more than one bike at the top and at the bottom (see, for example, FIG. 5 showing two bikes). The example is not meant to be limiting.

As shown and noted in FIG. 1, an exemplary two-story high system 100 may support up to eight bikes, one at the bottom of the conveyor 110, one at the top, and three on each side. In an exemplary one-story high system, up to 4 bikes may be stored, one at the bottom of the conveyor, one at the top, and one on each side. These exemplary numbers are based on a typical height of a story of about ten feet. If a story is higher, the numbers may be higher.

FIG. 2 illustrates an exemplary partial side (profile) view 200 of the parking and charging station 100, showing one bike, according to some embodiments of the present disclosure. The system 100 may include a plurality of horizontal connecting bars 210 each can support one or two bikes. Each connecting bar 210 may be connected to a bar 212, as described in previous application referenced above (see, for example, U.S. Non-Provisional application Ser. No. 15/711,720), at one end. The bar 212 may include one or more universal links or mounts 216 that may provide dual functions of charging and locking of the e-bikes docked to the bar 212. At the other end, the connecting bar 210 may include a base 214 connected to the conveyor 110. As noted, the conveyor 110 may rotate using wire, chain, band, or suitable devices. FIG. 2 illustrates an example of the bar supporting one bike 220.

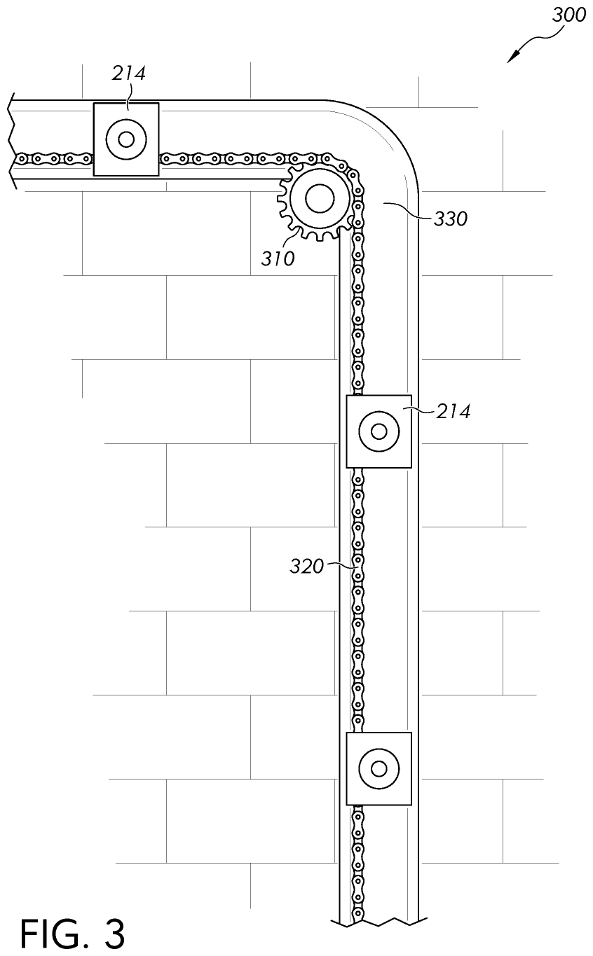

FIG. 3 illustrates an exemplary sectional side view of a rotating connecting mechanism 300, according to some embodiments of the present disclosure. The rotating connecting mechanism 300 may include one or more motorized sprockets 310 that connect to a chain, or band, or suitable mechanism 320 to rotate the conveyor 110. One or more connecting bars 210 may be connected to the chain or band 320 at the base 214. The chain, or band, 320 and the base 214 of the horizontal connecting bar 210 are moveably fit inside a channel 330 of the conveyor 110. As the sprockets 310 turn, they move the chain, or band, 320 which moves the horizontal connecting bars 210.

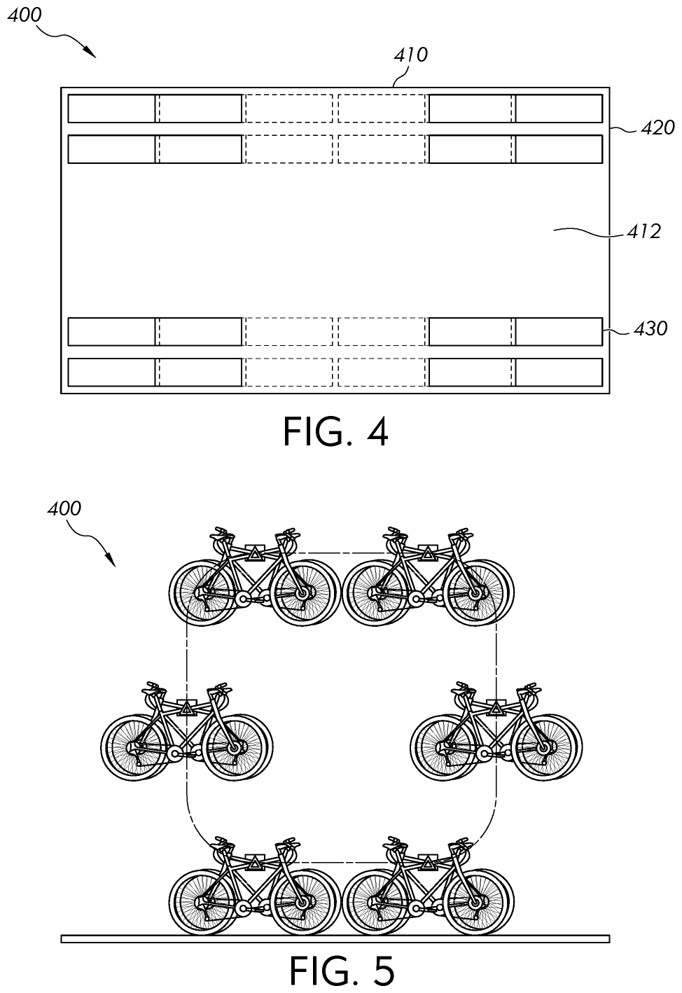

FIG. 4 illustrates an exemplary top or aerial view of a parking and charging station system 400 for all types of electric and non-electric bikes and scooters, according to some embodiments of the present disclosure. The parking and charging station system 400 is shown to fit in a typical parking space, e.g., in a parking lot 410. The parking space (or area) 410 is typically approximately about 8-10 feet wide by 18 feet long. Therefore, two conveyors 420 and 430 as described above can be put on each side of parking space 410 allowing an approximately 4 feet access way 412 between the two conveyors 420 and 430. Each conveyor can have 1-2 bikes per bar in this example. Therefore, each parking space 410 can hold 12-24 bikes.

FIG. 5 illustrates an exemplary front view of one conveyor of the parking and charging station system 400. Looking from the front, six bikes are visible when all parking spaces are used to parked and charged bikes on one conveyor. Up to another six bikes can be mounted (parked) behind the six visible bikes. As noted above, a larger parking space (or area) may hold longer (wider) conveyors and/or deeper carrier bars.

It should be noted that although the above examples illustrated vertical parking and charging stations which are above ground, the vertical parking and charging station of the present disclosure may also be underground, with the same components, functions and features. Or the system may be partially above ground and partially underground.

In some embodiments, the parking and charging station of the present disclosure may be electrified by being hard wired to an electrical grid to provide charging power to the e-bikes while the e-bikes are mounted on the universal links (or mounts), bars and conveyor(s).

In some embodiments, the parking and charging station of the present disclosure may include one or more solar panels coupled to the conveyor(s) and universal links. The parking and charging station may be electrified by solar panels and may provide charging power to the e-bikes while the e-bikes are mounted on the conveyor(s) and universal links (or mounts). In some embodiments, the parking and charging station of may include battery storage to store power from the solar panels and use for charging the e-bikes.

In some embodiments, the parking and charging station of the present disclosure may include smart capability that can communicate with a smart device, e.g. a smartphone, application (or “app”). In some embodiments, the universal link (or mount) of the parking and charging station may allow communication and data transfer so that a company or an individual may know if their bike is charged, and/or if a space is available for their private bike. In some embodiments, the company or individual may be able to reserve a space ahead of time, fleet bike owners can see the status of their bikes, how many are at the parking and charging station, who has reserved them and when, and the battery status, etc. Renters can see, e.g., via the phone app if there is a bike that is available for rent at any particular parking hub/station. A person with skill in the art will understand that the above are only examples of data and information that can be communicated and transferred between the parking and charging station and a server or user device but are not meant to be limited.

The communication and data transfer may be done using wired and/or wireless communications as known in the art. A person with skill in the art will understand that the universal link (or mount) of the parking and charging station includes hardware, software and power source needed for operation of the parking and charging station and for communication and data transfer.

In some examples, the universal links/mounts can be made to recognize bar codes, RFID (radio-frequency identification) chips, etc., and therefore the type or owner of the cargo that a vehicle is transporting or that is being stored at a parking hub can be identified for personal and company data gathering purposes.

In other examples, the universal links/mounts can detect the weight of the bike.

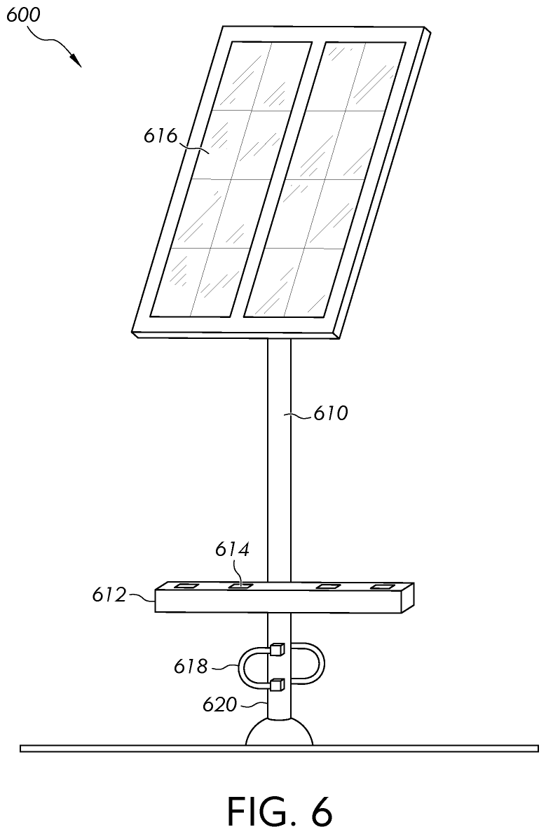

Referring to FIG. 6, an exemplary public charging station 600 for e-bikes and e-scooters, according to some embodiments, is shown. In some embodiments, the public charging station 600 may include a vertical post 610 installed securely on a horizontal platform, such as in a publicly accessible charging area (e.g., sidewalks, parking lots, malls, buildings, etc.). The vertical post 610 may include one or more bar 612 attached horizontally to the post 610. The bar 612 may include a plurality of universal links or mounts 614 (as described in U.S. Non-Provisional application Ser. No. 15/711,720 and above). The mounts 614 may provide dual functions of charging and locking of the e-bikes docked to the bar 612. The bars 612 with the universal mounts 614 may be arranged in an infinite number of patterns. These ‘smart’ universal charging and locking mounts may be situated in bars that are supported and arranged in many different patterns (e.g. on a wall, on a u-shaped bar, any type of bar extending from the ground, wall, another vehicle, etc.).

In some embodiments, the vertical post 610 can also include one or more closed loop bars 618 to which other bikes, e.g., bikes not having corresponding charging mechanism to work with the mounts 614, can be locked and charged with an extension charging wire 620 (with proper connection tips).

In some embodiments, the public charging station 600 may be electrified by being hard wired to an electrical grid may provide charging power to the e-bikes while the e-bikes are mounted on the bar 612 and the mounts 614.

In some embodiments, the public charging station 600 may include one or more solar panels 616 attached to the post 610 at or near the top portion of the post 610. The charging station 600 may be electrified by solar panels and may provide charging power to the e-bikes while the e-bikes are mounted on the bar 612 and the mounts 614. In some embodiments, the public charging station 600 may include battery storage to store power from the solar panels and use for charging the e-bikes.

In some embodiments, the public charging station 600 may include smart capability, similar to that of the parking and charging system described above in FIGS. 1-5, that can communicate with a smart device, e.g. a smartphone, application such that through the application (or “app”), a user can see, for example. which charging station 600 (or dock) in his or her vicinity has how many bikes to rent, see how many spaces to place one's own bike, see how full each of the batteries are charged, see whether the batteries need replacing, and reserve a bike for the near future (for a fee), etc. A person with skill in the art will understand that the above examples are not limiting, and other applications may also be included.

Although examples above depict the docking, locking and charging of e-bikes, it should be noted that the public charging station 600 may also be used for charging other vehicles, such as e-cars, e-buses and other public vehicles. It should also be noted that non-electric bikes may also be parked and locked at the charging station 100, 400 and 600.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

These embodiments and others described herein are improvements in the fields of electric vehicle parking and charging stations. The various configurations of these devices are described by way of the embodiments which are only examples.

It is to be understood that this disclosure is not limited to the particular embodiments described herein, as such may, of course, vary. It is also to be understood that the terminology used herein is for the purpose of describing particular embodiments only and is not intended to be limiting.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

What is claimed is:

1. A parking and charging station for electric bicycles and electric scooters, comprising:
a vertical conveyor connected to a power source and a communication network;
a plurality of horizontal connecting bars attached to the conveyor at a first end of each of the horizontal connecting bars, and attached to a carrier bar at a second end of each of the horizontal connecting bars; and
wherein each carrier bar includes one or more universal mounts, and wherein each of the one or more universal mounts provides at least one of locking, charging and data transfer mechanisms.

2. The parking and charging station of claim 1, wherein each of the plurality of horizontal connecting bars is attached to the vertical conveyor at a base of the each of the plurality of horizontal connecting bars.

3. The parking and charging station of claim 1, wherein the carrier bar includes two universal mounts.

4. The parking and charging station of claim 1, wherein each of the one or more universal mounts receives an electric bicycle or an electric scooter.

5. The parking and charging station of claim 1, wherein the vertical conveyor is above ground.

6. The parking and charging station of claim 1, wherein the vertical conveyor is underground.

7. The parking and charging station of claim 1, wherein the vertical conveyor is partially above ground.

8. The parking and charging station of claim 1 is further hard wired to an electrical grid to provide charging power to the electric bicycles and electric scooters.

9. The parking and charging station of claim 1 further comprises a solar panel to provide charging power to the electric bicycles and electric scooters.

10. The parking and charging station of claim 1 further comprises a battery storage.

11. The parking and charging station of claim 1 further comprises a smart capability that can communicate with a smart device.

12. The parking and charging station of claim 1 further comprises one or more motorized sprockets connecting to a chain for rotating the vertical conveyor.

13. The parking and charging station of claim 1, wherein the one or more universal mounts recognize one of bar codes and RFID chips.

14. The parking and charging station of claim 1, wherein the one or more universal mounts detects a weight of an electric bicycle or an electric scooter.

15. A parking and charging station for electric bicycles and electric scooters, comprising:
a vertical post installed securely on a horizontal platform;
one or more bars attached horizontally to the vertical post; and
one or more universal mounts attached to the bar, wherein the one or more universal mounts provide locking and charging mechanisms for locking and charging electric bicycles and electric scooters mounted on the universal bar

16. The parking and charging station of claim 15 is further hard wired to an electrical grid to provide charging power to the electric bicycles and electric scooters.

17. The parking and charging station of claim 15 further comprises a solar panel to provide charging power to the electric bicycles and electric scooters.

18. The parking and charging station of claim 15 further comprises a battery storage.

19. The parking and charging station of claim 15 further comprises a smart capability that can communicate with a smart device.

20. The parking and charging station of claim 15 further comprises one or more closed loop bars.
